(19) United States
(12) Patent Application Publication
(10) Pub. No.: US 2025/0306249 A1
(43) Pub. Date: Oct. 2, 2025

(54) MULTILAYER FILM, OPTICAL MEMBER, IMAGING DEVICE, AND METHOD OF PRODUCING MULTILAYER FILM

(71) Applicant: FUJIFILM Corporation, Tokyo (JP)

(72) Inventor: Hiroki TAKAHASHI, Saitama (JP)

(73) Assignee: FUJIFILM Corporation, Tokyo (JP)

(21) Appl. No.: 19/084,724

(22) Filed: Mar. 19, 2025

(30) Foreign Application Priority Data
Mar. 28, 2024 (JP) 2024-055000

(51) Int. Cl. G02B 1/18; G02B 1/115

(52) U.S. Cl. CPC G02B 1/18; G02B 1/115

(57) ABSTRACT

A multilayer film that is provided on a substrate includes: a silicon oxide layer that has a moth eye structure on a surface thereof and exhibits hydrophilicity; and a titanium oxide layer that is disposed in contact with the silicon oxide layer and exhibits a photocatalytic function.

### CROSS REFERENCE TO RELATED APPLICATIONS

This application claims priority from Japanese Application No. 2024-055000, filed on Mar. 28, 2024, the entire disclosure of which is incorporated herein by reference.

### BACKGROUND

### 1. Technical Field

The present disclosure relates to a multilayer film, an optical member, an imaging device, and a method of producing the multilayer film.

### 2. Related Art

In an optical member used in a camera or the like, in a case where water droplets are formed on a surface of the optical member due to condensation, the water droplets scatter light, resulting in a deterioration in image quality in the camera. Furthermore, in a case where condensation and drying are repeated, dirt remains on the surface of the optical member, and the dirt scatters and shields light, resulting in a deterioration in image quality. In addition, the dirt causes a decrease in hydrophilicity, and water droplets are likely to be formed. In optical members disposed in a closed space, it is difficult to remove water droplets and dirt. As a countermeasure, a method is provided in which a hydrophilic layer is disposed on a surface of an optical member to suppress the formation of water droplets and a photocatalytic layer is disposed to decompose organic substances contained in dirt. In addition, the optical member is desired to have low reflectivity to incidence rays.

WO2020/129558A discloses a multilayer film having characteristics such as hydrophilicity, photocatalytic properties, and low reflectivity, in which an antireflection layer is provided on a surface of a substrate, a photocatalytic layer consisting of titanium oxide is provided on a surface of the antireflection layer, and a layer consisting of silicon oxide and having fine pores formed therein is formed on a surface of the photocatalytic layer.

### SUMMARY

An object of the present disclosure is to provide a multilayer film having excellent hydrophilicity and photocatalytic properties, an optical member including the multilayer film, and a method of producing the multilayer film.

A multilayer film according to an embodiment of the present disclosure is a multilayer film comprising, on a substrate: a silicon oxide layer that has a moth eye structure on a surface thereof and exhibits hydrophilicity; and a titanium oxide layer that is disposed in contact with the silicon oxide layer and exhibits a photocatalytic function.

The titanium oxide layer of the multilayer film according to the embodiment of the present disclosure is preferably disposed between the silicon oxide layer and the substrate.

The silicon oxide layer of the multilayer film according to the embodiment of the present disclosure preferably includes a functional group exhibiting hydrophilicity.

The moth eye structure of the multilayer film according to the embodiment of the present disclosure preferably has a height of 120 nm to 400 nm, and a period of 80 nm to 220 nm.

In the multilayer film according to the embodiment of the present disclosure, the titanium oxide layer preferably has a film thickness of 250 nm to 500 nm, and ultraviolet irradiation energy necessary for photocatalytic activity is preferably 7 J/cm² or less.

In the multilayer film according to the embodiment of the present disclosure, a water contact angle is preferably 5° or less. The water contact angle can be measured by a commercially available contact angle meter. In the present specification, the water contact angle is a static contact angle measured with a water droplet amount of 1 μL.

In the multilayer film according to the embodiment of the present disclosure, a haze is preferably 3.2% or less.

In the multilayer film according to the embodiment of the present disclosure, an interlayer having an antireflection function is preferably provided between the substrate and the titanium oxide layer.

An optical member according to an embodiment of the present disclosure is an optical member comprising: the multilayer film according to the embodiment of the present disclosure; and the substrate with the multilayer film provided on a surface thereof, in which the substrate is a flat substrate having a flat surface or an optical lens having a predetermined curvature.

In the optical member according to the embodiment of the present disclosure, reflectivity is preferably 0.05% or less in a case where light having a wavelength of 400 nm to 700 nm is vertically incident.

An imaging device according to an embodiment of the present disclosure is an imaging device comprising: the optical member according to the embodiment of the present disclosure.

A method of producing a multilayer film according to an embodiment of the present disclosure is a method of producing the multilayer film according to the embodiment of the present disclosure.

According to the technique of the present disclosure, it is possible to obtain a multilayer film having excellent hydrophilicity and photocatalytic properties, an optical member including the multilayer film, and a method of producing the multilayer film.

### BRIEF DESCRIPTION OF THE DRAWINGS

FIG. 1 is a schematic cross-sectional view of an optical member according to one embodiment.

FIG. 2 is a schematic cross-sectional view of an optical member of a modification example.

FIG. 3 is a diagram showing production steps of the optical member according to one embodiment.

FIG. 4 is a diagram showing details of a mask forming step.

FIG. 5 is a diagram showing details of an etching step.

FIG. 6 is a perspective view of an imaging device according to one embodiment.

FIG. 7 is a diagram showing spatial frequency spectra of samples 1-1 to 1-8.

(1A) in FIG. 8 is an example of an SEM image of a surface of the sample 1-8, and (1B) in FIG. 8 is an example of an SEM image of a cross section of the sample 1-8. (2A) in FIG. 8 is an example of an SEM image of a surface of a sample in which an aluminum oxide film is formed instead of an aluminum nitride film of the sample 1-8, and (2B) in FIG. 8 is an example of an SEM image of a cross section of the sample in which an aluminum oxide film is formed instead of an aluminum nitride film of the sample 1-8.

FIG. 9 is a diagram showing average irregularity heights and average irregularity periods of samples 2-1 to 2-8 and samples 3-1 to 3-8.

FIG. 10 is a diagram showing the dependence of photocatalytic activity of samples 4-1 to 4-5 on ultraviolet irradiation energy.

FIG. 11 is a diagram showing the dependence of photocatalytic activity of comparative samples on ultraviolet irradiation energy.

FIG. 12 is a diagram showing a change in refractive index of a moth eye structure.

FIG. 13 is a graph showing reflectivity of a sample 5-1.

FIG. 14 is a graph showing reflectivity of a sample 5-4.

### DESCRIPTION OF EMBODIMENTS

Hereinafter, embodiments of the present disclosure will be described with reference to the drawings. For easy visual recognition, a film thickness and a ratio of each layer are appropriately changed and drawn, and do not necessarily reflect the actual film thickness and ratio. In the present specification, numerical ranges represented by “to” include numerical values before and after “to” as lower limits and upper limits.

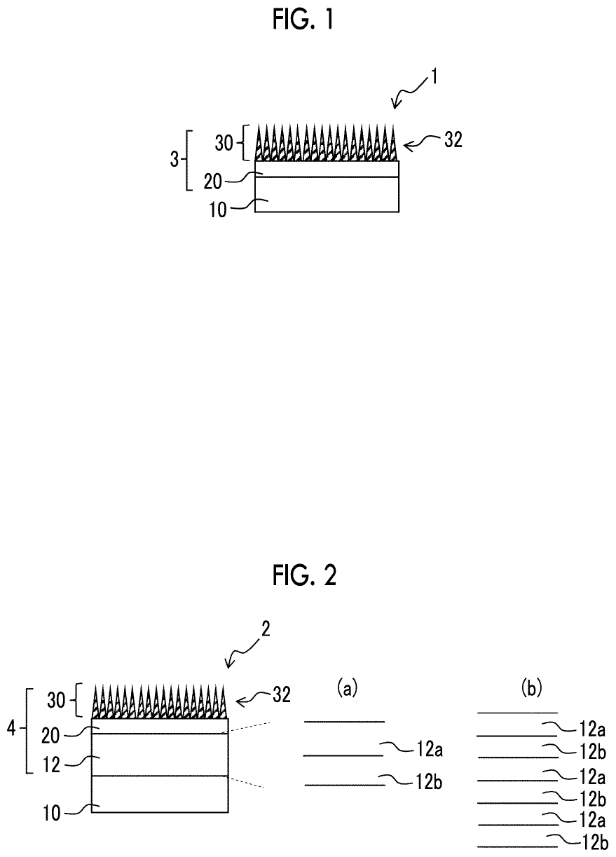

FIG. 1 is a cross-sectional view of an optical member according to one embodiment. The optical member 1 includes an optical substrate 10 having a flat surface and a multilayer film 3 according to one embodiment. The multilayer film 3 includes a titanium oxide layer 20 provided on the optical substrate 10 and a silicon oxide layer 30 having a moth eye structure 32 on a surface thereof. In the present example, the titanium oxide layer 20 is disposed between the silicon oxide layer 30 and the optical substrate 10. The silicon oxide layer 30 has a moth eye structure 32 on the surface thereof and exhibits hydrophilicity. The titanium oxide layer has a photocatalytic function. Therefore, the multilayer film 3 has hydrophilicity and photocatalytic activity. The water contact angle of a surface of the multilayer film 3 is preferably 10° or less, and more preferably 5° or less. The water contact angle can be measured by a commercially available contact angle meter. In the present specification, the water contact angle is a static contact angle measured with a water droplet amount of 1 μL.

The optical substrate 10 is an example of a substrate of the present disclosure. The shape of the optical substrate 10 is not particularly limited, and it may be a transparent substrate that is primarily used in optical devices, such as a flat substrate having a flat surface or an optical lens such as a concave lens or a convex lens having a predetermined curvature, and may be a substrate composed of a combination of a curved surface having a predetermined positive or negative curvature and a plane.

The titanium oxide layer 20 is preferably a film produced by a vapor phase film forming method. Specifically, the titanium oxide layer 20 is preferably a sputtering film formed by a sputtering method, a vapor-deposited film formed by a vapor deposition method, or the like. The titanium oxide layer 20 is preferably an anatase type.

In a case where the composition of the titanium oxide contained in the titanium oxide layer 20 is represented by TiOx, 1.90≤x≤2.00 is preferable, and 1.95≤x≤2.00 is more preferable.

The titanium oxide layer 20 has a film thickness of 250 nm to 500 nm, and the ultraviolet irradiation energy necessary for the photocatalytic activity is preferably 7 J/cm² or less. From the viewpoint of the photocatalytic activity, the film thickness of the titanium oxide layer 20 is desirably 300 nm or more, more desirably 400 nm or more, and most desirably 500 nm. However, from the viewpoint of the balance between the ultraviolet irradiation energy and the reflectivity, the film thickness of the titanium oxide layer 20 is desirably 250 nm to 300 nm.

The silicon oxide layer 30 has the moth eye structure 32. In the silicon oxide layer 30, the aluminum content is 0.25 wt. % or less, the calcium content is 2.0 wt. % or less, the boron content is 2.0 wt. % or less, and the carbon content is 6.0 wt. % or less. The aluminum content is preferably 0.1 wt. % or less, the calcium content is preferably 1.0 wt. % or less, the boron content is preferably 1.0 wt. % or less, and the carbon content is preferably 4.0 wt. % or less.

The content of a component contained in the silicon oxide layer 30 can be measured by X-ray photoelectron spectroscopy (XPS).

In a case where the composition of the silicon oxide contained in the silicon oxide layer 30 is represented by SiOx, 1.90≤x≤2.00 is preferable, and 1.95≤x≤2.00 is more preferable.

The moth eye structure 32 is a structure including a plurality of protruding portions having such a shape that a cross-sectional area gradually decreases from a bottom surface (substrate side) of the silicon oxide layer 30 toward a surface. In FIG. 1, the moth eye structure 32 is a structure in which protruding portions having a triangular cross section are regularly disposed, but in the present specification, the moth eye structure refers to a structure in which a large number of protruding portions having a tapered tip shape are regularly or irregularly disposed. Due to such a shape, the refractive index of the moth eye structure gradually decreases from the bottom surface toward the surface, and the moth eye structure exhibits a change in refractive index at an outermost surface, where the refractive index is 1, which is substantially the same as that of air.

The average height of the moth eye structure 32 is preferably 120 nm to 400 nm, and the average period is preferably 80 nm to 220 nm. The average height is more preferably 300 nm or less, and still more preferably 180 nm or less. The average period is more preferably 130 nm or less.

Methods of measuring the average height and the average period will be described in Examples below.

The silicon oxide layer 30 preferably includes a functional group exhibiting hydrophilicity in the surface. It is known that the silicon oxide layer 30 exhibits hydrophilicity since the surface thereof is covered with a hydroxyl group (—OH), which reduces a difference between surface free energy of water and surface free energy of the optical member. Furthermore, since the surface has the moth eye structure 32, the surface area per unit space increases and the concentration of hydroxyl groups per unit space increases, compared to a case where the surface is smooth. Therefore, the hydrophilicity is further exhibited. In addition, the hydrophilicity is further exhibited by setting gaps of the irregularities of the moth eye structure 32 to a size that allows water to enter.

Meanwhile, the functional group exhibiting hydrophilicity includes an amino group, a carbonyl group, a carboxyl group, a phenyl group, a methyl group, and the like in addition to the hydroxyl group, and the surface of the silicon oxide layer 30 may be modified with any of these groups. The surface of the silicon oxide layer 30 can be modified with the functional groups other than the hydroxyl group by immersing the multilayer film in a liquid substance containing the functional groups and then performing a plasma treatment on the silicon oxide multilayer film surface.

In the multilayer film 3, the haze is preferably 3.2% or less. The smaller the haze, the more preferable. The smaller the haze of the multilayer film 3, the smaller the scattering in the optical member, and the higher the quality of the optical member. Therefore, the smaller the haze of the multilayer film 3, the more preferable. The haze measurement can be performed by a commercially available haze meter.

As described above, the multilayer film 3 according to the present embodiment includes the titanium oxide layer 20 provided on the optical substrate 10 and the silicon oxide layer 30 having the moth eye structure 32 on the surface provided on the titanium oxide layer 20. The surface area of the silicon oxide layer 30 can be increased by providing the moth eye structure 32 on the surface of the silicon oxide layer 30. As a result, the difference between the surface free energy of water and the surface free energy of the multilayer film 3 is reduced. The smaller the difference between the surface free energy of water and the surface free energy of the multilayer film 3, the higher the hydrophilicity. By providing the moth eye structure 32 on the surface of the silicon oxide layer 30, the surface area can be increased compared to a case where a silicon oxide layer of a porous film or a silicon oxide layer of an orthorhombic film is provided, and thus high hydrophilicity can be obtained. In addition, since the silicon oxide layer 30 has the moth eye structure 32 and the distance between the bottom portion of the recesses of the irregularities and the titanium oxide layer 20 that is a photocatalytic layer is short, active species are generated with low ultraviolet energy, and the concentration of active species in the outermost surface of the multilayer film 3 can be increased. That is, the photocatalytic action of the titanium oxide layer 20 can be generated with low ultraviolet energy.

In the multilayer film 3 according to the present embodiment, in the silicon oxide layer 30, the aluminum content is 0.25 wt. % or less, the calcium content is 2.0 wt. % or less, the boron content is 2.0 wt. % or less, and the carbon content is 6 wt. % or less. With such a configuration, in a case where the silicon oxide layer 30 is subjected to vapor phase etching in the production of the optical member 1, it is possible to suppress the generation of a compound that reacts with an etching gas and inhibits etching. Accordingly, the moth eye structure 32 is easily formed.

In a case where the silicon oxide layer 30 is a film produced by a vapor phase film forming method, such as a sputtering film or a vapor-deposited film produced by a sputtering method or a vapor deposition method, it is possible to obtain a film in which the impurity concentration is sufficiently reduced.

The average height of the moth eye structure 32 is preferably 120 nm to 400 nm, and in a case where the average period is 80 nm to 220 nm, the haze can be suppressed.

### Modification Example

FIG. 2 is a cross-sectional view of an optical member 2 of a modification example. In FIG. 2, the same components as those in FIG. 1 are denoted by the same reference numerals. The optical member 2 includes an optical substrate 10 and a multilayer film 4 of the modification example. The multilayer film 4 of the modification example includes, between the optical substrate 10 and the titanium oxide layer 20, an interlayer 12 having an antireflection function that reduces reflectivity to incidence rays. In the present specification, the term “interlayer” means a layer provided between the optical substrate 10 and the titanium oxide layer 20.

As shown in (a) of FIG. 2, in the interlayer 12, a layer of high refractive index 12a having a relatively high refractive index and a layer of low refractive index 12b having a relatively low refractive index are preferably alternately laminated. In (a) of FIG. 2, the layer of low refractive index 12b and the layer of high refractive index 12a are alternately laminated in two layers in this order from the optical substrate 10 side. However, the number of layers in the multilayer film is not particularly limited, and as shown in (b) of FIG. 2, the interlayer 12 may have a six-layer configuration.

The layer of high refractive index 12a may have a higher refractive index than the layer of low refractive index 12b, and the layer of low refractive index 12b may have a lower refractive index than the layer of high refractive index 12a. However, it is more preferable that the layer of high refractive index 12a have a higher refractive index than the optical substrate 10, and the layer of low refractive index 12b have a lower refractive index than the optical substrate 10.

The layers of high refractive index 12a or the layers of low refractive index 12b may not have the same refractive index. However, it is preferable that the layers be formed of the same material and have the same refractive index from the viewpoint of suppressing material costs, film forming costs, and the like.

Examples of the material constituting the layer of high refractive index 12a include niobium pentoxide (Nb₂O₅), titanium oxide (TiO₂), zirconium oxide (ZrO₂), tantalum pentoxide (Ta₂O₅), silicon oxynitride (SiON), silicon nitride (Si₃N₄), and silicon niobium oxide (SiNbO).

Examples of the material constituting the layer of low refractive index 12b include silicon oxide (SiO₂), silicon oxynitride (SiON), gallium oxide (Ga₂O₃), aluminum oxide (Al₂O₃), lanthanum oxide (La₂O₃), lanthanum fluoride (LaF₃), magnesium fluoride (MgF₂), and sodium aluminum fluoride (Na₃AlF₆).

The refractive index can be changed to some extent by forming a film by controlling any of these compounds to have a constitutional element ratio shifted from the compositional ratio of the stoichiometric ratio or by controlling the film forming density.

The multilayer film 4 functions as an antireflection film since it includes the interlayer 12 having an antireflection function. The multilayer film 4 preferably has average reflectivity of 0.1% or less, and more preferably 0.05% or less at a wavelength of 400 nm to 700 nm.

In the optical member 2 including the multilayer film 4, the average reflectivity is preferably 0.1% or less, and more preferably 0.05% or less in a case where light having a wavelength of 400 nm to 700 nm is vertically incident on the substrate surface. The average reflectivity means an average of reflectivities at respective wavelengths within a wavelength of 400 nm to 700 nm. The lower the reflectivity, the higher the antireflection performance.

Light is allowed to incident on the optical member 2 at an incidence angle of 5° to measure the reflectivity for each wavelength. The dependence of the reflectivity on wavelength can be measured by a commercially available spectrometer.

In the moth eye structure 32 on the surface of the silicon oxide layer 30, the refractive index in the film thickness direction gradually decreases from the optical substrate 10 side toward the surface side (for example, see FIG. 12). Such a change in refractive index provides an effect of preventing the light incident from the surface side from being reflected, and a significant antireflection effect is obtained by the synergistic effect of providing the moth eye structure 32 and the interlayer 12.

### Production Method

A method of producing the optical member 1 including a method of producing the multilayer film 3 according to one embodiment will be described.

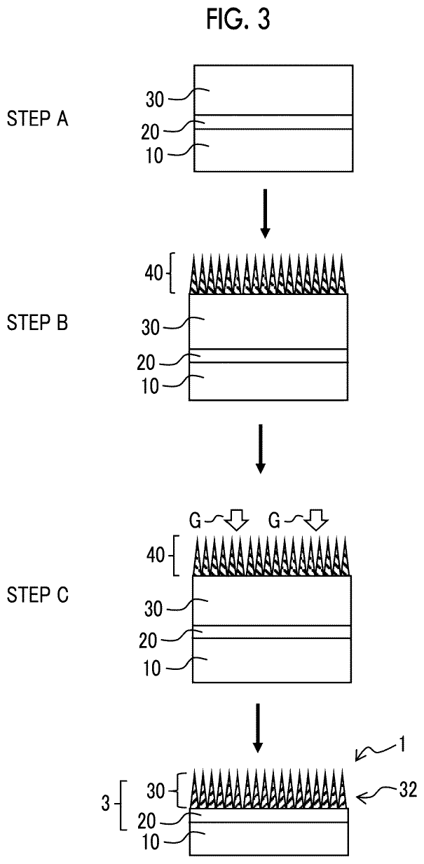

As shown in FIG. 3, the method of producing the optical member 1 includes Steps A to C. Step A is a step of forming the titanium oxide layer 20 and the silicon oxide layer 30 on the optical substrate 10. Step B is a mask forming step of forming a mask 40 on the silicon oxide layer 30. Step C is an etching step of subjecting the silicon oxide layer 30 to vapor phase etching using the mask 40 and an etching gas G.

In the film forming step (Step A), the titanium oxide layer 20 and the silicon oxide layer 30 are sequentially formed on one surface of the optical substrate 10 by a vapor phase film deposition method. Examples of the vapor phase film deposition method include a sputtering method, a vacuum deposition method, and a chemical vapor deposition method, and a sputtering method is particularly suitable. Using the vapor phase film deposition method, it is possible to suppress the incorporation of impurities into the titanium oxide layer 20 and the silicon oxide layer 30. That is, a sputtering film formed by a sputtering method, a vapor-deposited film formed by a vacuum deposition method, or the like can be said to be a film in which the incorporation of elements (that is, impurities) other than the target is sufficiently suppressed.

In a case where the silicon oxide layer 30 is formed by a sputtering method, a SiO2 target is used, oxygen is introduced into a film forming chamber, and a flow rate of the oxygen is adjusted. Thus, the value of x in the silicon oxide (SiOx) can be optionally adjusted.

The film thickness of the titanium oxide layer 20 is, for example, 250 nm to 500 nm.

The film thickness of the silicon oxide layer 30 is, for example, 500 nm to 1,500 nm.

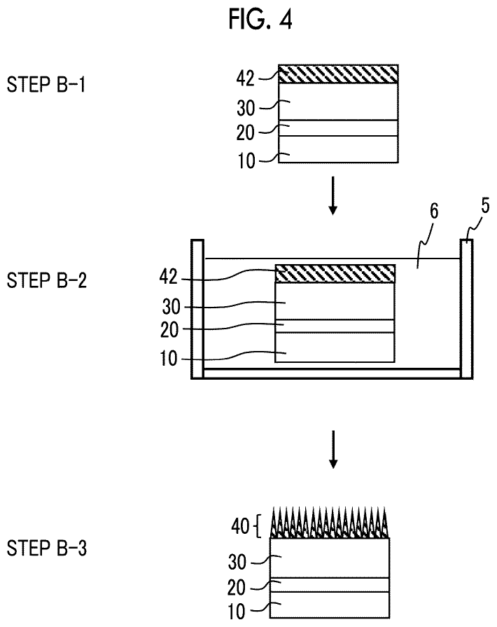

Details of the mask forming step (Step B) are shown in FIG. 4. The mask forming step includes, for example, Step B-1: an Al-containing thin film forming step of forming a thin film 42 (hereinafter, referred to as an Al-containing thin film 42) containing aluminum on the silicon oxide layer 30, and Step B-2: a hot water treatment step of subjecting the Al-containing thin film 42 to a hot water treatment, as shown in FIG. 4.

In the Al-containing thin film forming step (Step B-1), the Al-containing thin film 42 is formed by a vapor phase film deposition method. Examples of the vapor phase film deposition method include a sputtering method, a vacuum deposition method, and a chemical vapor deposition method, and a sputtering method is particularly suitable. In a case where the silicon oxide layer 30 is formed by a sputtering method, the Al-containing thin film 42 is preferably continuously formed in the same chamber.

Examples of the Al-containing thin film 42 include an aluminum film, an aluminum oxide film, and an aluminum nitride film. The film thickness of the Al-containing thin film 42 is preferably 10 nm to 40 nm. An aluminum nitride film is particularly preferably used.

The hot water treatment in the hot water treatment step (Step B-2) refers to a treatment in which exposure to hot water at 60° C. or higher is performed for 20 seconds or longer. Examples of the hot water treatment include a method in which a laminate in which the Al-containing thin film 42 is formed is immersed in water (particularly preferably pure water) at room temperature, and the water is boiled, a method in which the laminate is immersed in hot water maintained at a high temperature, and a method in which the Al-containing thin film 42 is exposed to a stem at a high temperature. In the present embodiment, pure water 6 accommodated in a water tank 5 is heated, and a laminate consisting of the optical substrate 10, the titanium oxide layer 20, the silicon oxide layer 30, and the Al-containing thin film 42 is immersed in the heated pure water 6 for the hot water treatment. The boiling or immersing time is particularly preferably 3 minutes or longer and 15 minutes or shorter. The temperature of the hot water is particularly desirably higher than 90° C. The higher the temperature, the shorter the treatment time tends to be.

Due to the hot water treatment, the Al-containing thin film 42 is changed to an irregular structure layer containing alumina hydrate as a main component, as shown in Step B-3. The irregular structure layer corresponds to the mask 40. The irregular structure layer 40 described below is synonymous with the mask 40. The alumina hydrate constituting the irregular structure layer 40 is boehmite (expressed as Al₂O₃ ·H₂O or AlOOH), which is alumina monohydrate, bayerite (expressed as Al₂O₃ ·3H₂O or Al (OH)₃), which is alumina trihydrate (aluminum hydroxide), or the like.

In the irregular structure layer 40, the irregular structure has random heights and periods of the irregularities, and has a substantially sawtooth-shaped cross section although the protruding portions have various sizes (apex angle sizes) and orientations.

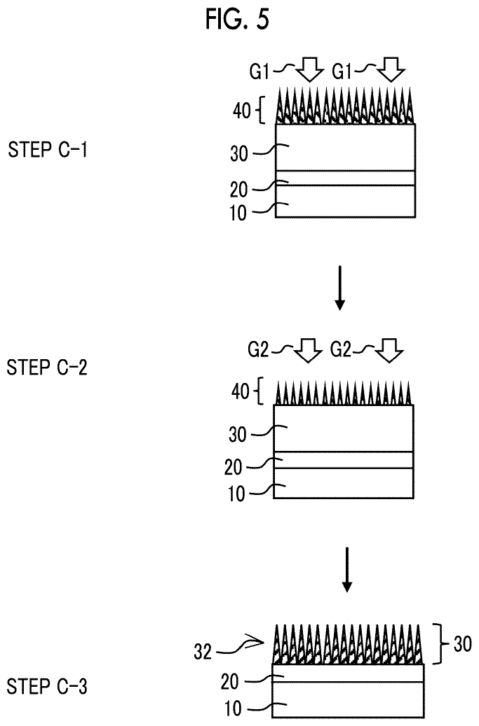

Details of the etching step (Step C) are shown in FIG. 5. The etching step includes, for example, Step C-1: a physical etching step of physically etching the irregular structure layer 40 according to the shape of the irregular structure layer 40, and Step C-2 to be performed after Step C-1: a reactive etching (chemical etching) step of selectively etching the silicon oxide layer 30 exposed on the recessed portions of the irregular structure layer 40, as shown in FIG. 5.

In the physical etching step (Step C-1), the irregular structure layer 40 consisting of alumina hydrate is etched to expose the silicon oxide layer 30 on the recessed portions of the irregular structure layer 40. Here, for example, a mixed gas of argon (Ar) and CHF₃ (trifluoromethane) is used as the etching gas G1. The physical etching time is, for example, preferably from approximately 15 seconds to 60 seconds, and more preferably from 30 seconds to 45 seconds.

In the chemical etching step (Step C-2), the silicon oxide layer 30 exposed on the recessed portions is etched. For example, a mixed gas of SF₆ (sulfur hexafluoride) and CHF₃ is used as an etching gas G2. In this case, SF₆ that is a reactive gas is allowed to act on SiO2 to generate SiF₄, and SiF₄ is vaporized to chemically etch SiO₂. In this chemical etching step, the etching is performed until a distance d2 from the surface of the silicon oxide layer 30 on the optical substrate 10 side to the top of a maximum protruding portion of the moth eye structure is smaller than a film thickness d1 of the silicon oxide layer 30 immediately after the film formation. The chemical etching time is, for example, preferably from 1 minute to 35 minutes, more preferably from 1 minute to 25 minutes, and particularly preferably from 10 minutes to 25 minutes.

After the chemical etching step, a cleaning treatment step (Step C-3) is performed to remove the irregular structure layer 40 remaining on the surface of the silicon oxide layer 30.

In the cleaning treatment step (Step C-3), the irregular structure layer 40 is removed with SH303 (a mixed solution of sulfuric acid and hydrogen peroxide), and drying is performed. Then, ultraviolet (UV) irradiation is performed. The ultraviolet irradiation is performed to decompose unnecessary organic substances incorporated during the production process. In the production environment in which incorporation can be ignored, ultraviolet irradiation is not essential.

Through the above steps, the optical member 1 can be produced.

In a case where the optical member 2 including the interlayer 12 and the titanium oxide layer 20 is produced, the interlayer 12 and the titanium oxide layer 20 are formed before the silicon oxide layer 30 is formed on the optical substrate 10. The vapor phase film deposition method is also preferably used to form the interlayer 12 and the titanium oxide layer 20. According to the vapor phase film deposition, a laminated structure having various refractive indexes and layer thicknesses can be easily formed.

In the above-described chemical etching, in a case where the silicon oxide layer 30 contains an impurity element that generates a compound that is difficult to react with an etching gas and gasify, the reaction between SiO₂ and the reactive gas may be inhibited. In a case where the reaction between SiO₂ and the reactive gas is inhibited, a problem occurs in that the etching rate slows down or is unstable, or the etching does not proceed. Examples of the impurity element that generates a fluorine compound that is difficult to react with SF₆ and gasify include aluminum, calcium, boron, and carbon. As described above, in a case where the silicon oxide layer 30 is formed by a vapor phase film deposition method such as film formation by sputtering using a SiO₂ target, the incorporation of these impurity elements can be sufficiently suppressed compared to the film formation by a liquid phase film forming method such as sol-gel, and a problem of etching inhibition does not occur in the chemical etching step.

In addition, optical substrates used in cover glass, lenses, and the like may contain a metal (for example, Al or Ca) other than Si to lower a softening point or adjust a refractive index. Therefore, in a case where an irregular structure is directly formed on the surface of the optical member by etching the surface of the optical substrate, the above-described problem may occur in the chemical etching step of Step C-2, and it may take time to form the irregular structure or it may not be possible to form an irregular structure having a sufficient depth. In the present method of producing the optical member 1, the silicon oxide layer 30 is formed on the optical substrate 10, and thus even in a case where impurity elements are incorporated in the optical substrate 10, the optical substrate 10 can be applied without any problem regardless of the material thereof.

Since the above-described optical members 1 and 2 have high hydrophilicity and a high self-cleaning function, they are suitable as optical members disposed in a part where condensation is likely to adhere, such as an optical lens of an endoscope camera, a surveillance camera, or an in-vehicle camera.

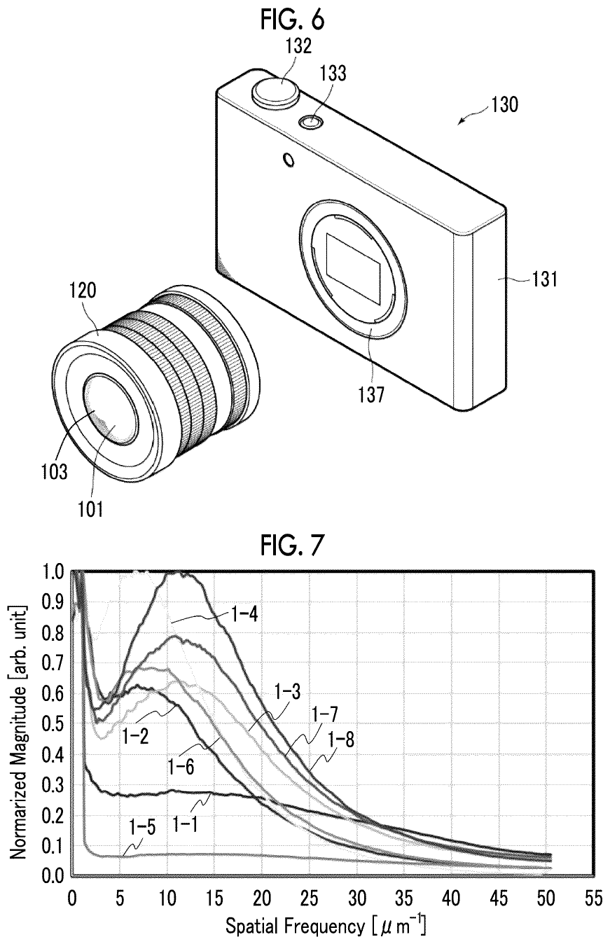

An imaging device according to an embodiment of the present disclosure will be described. FIG. 6 is a perspective view showing the appearance of a camera 130 that is an imaging device according to one embodiment of the present disclosure. The camera 130 is a so-called mirrorless type digital camera, and an interchangeable lens 120 can be removably mounted thereon. The interchangeable lens 120 is configured to include a zoom lens housed in a lens barrel. For example, an optical member 101 according to one embodiment of the present disclosure is applied as a lens disposed on the outermost side among the optical lenses constituting the zoom lens. The optical member 101 includes a multilayer film 103 according to one embodiment of the present disclosure on a surface side exposed to the outside.

The camera 130 includes a camera body 131, and a shutter button 132 and a power button 133 are provided on an upper surface of the camera body 131. In addition, an operating portion and a display portion are provided on a rear surface (not shown) of the camera body 131. The display portion can display a captured image and an image within an angle of view before imaging.

An imaging opening on which light from an imaging target is incident is provided in a center portion of a front surface of the camera body 131, and a mount 137 is provided at a position corresponding to the imaging opening. The interchangeable lens 120 is mounted on the camera body 131 through the mount 137.

In the camera body 131, there are provided an imaging element such as a charge coupled device (CCD) or a complementary metal oxide semiconductor (CMOS) that outputs an imaging signal based on a subject image formed through the interchangeable lens 120, a signal processing circuit that generates an image by processing the imaging signal output from the imaging element, a recording medium for recording the generated image, and the like.

### EXAMPLES

Samples for Examples and Comparative Examples of multilayer films and optical members are produced, and various tests are performed to describe results of verification of the multilayer film and the optical member according to the embodiment of the present disclosure.

In the production of samples used in tests, an RF magnetron sputtering device BMS-800II (SHINCRON CO., LTD.) was used as a film forming device. Film forming conditions for each film will be described later.

Characteristics of each sample were measured by the following measuring methods.

Water Contact Angle

A contact angle meter (DM300: Kyowa Interface Science Co., Ltd.) was used to measure a water contact angle. Here, a static contact angle was measured with a water droplet amount of 1 μL. In the present specification, a water contact angle is used as a measure of hydrophilicity, but a contact angle of a liquid other than water may be used. For example, a contact angle may be measured using n-hexadecane, ethylene glycol, or the like instead of water to evaluate the hydrophilicity. A liquid having smaller surface free energy than water (72.8 mN/m) may be used as a liquid for measuring a contact angle. For more detailed definition, in a case where a liquid in which the dispersion component of surface energy thereof is close to the dispersion component of surface energy of water is used, it is possible to evaluate the hydrophilicity based on the magnitude relationship of contact angles similar to the magnitude relationship of water contact angles. As a numerical value of the dispersion component of the liquid to be used, the numerical value described in JP4012891B may be used.

Average Height of Irregularities

The average height of irregularities, that is an average height from the bottom of recessed portions of a fine irregular structure (moth eye structure) formed on the surface of the silicon oxide layer to the top of protruding portions, was derived as follows.

First, a cross section of the optical member was imaged by a scanning electron microscope (SEM) at a magnification of 50,000 times to acquire an SEM image. The SEM image was binarized to detect edges of the irregular structure, a filling treatment was performed to fill the recessed portions, thereby removing noise, and a boundary between air and the irregularities as a surface of the irregularities was determined. Through these processes, a boundary line of the irregularities where the deepest position was defined to correspond to a height of 0 was obtained. In a case where the irregularity heights in the obtained boundary line are integrated and averaged, the average height of the irregularities can be obtained.

Average Period of Irregularities

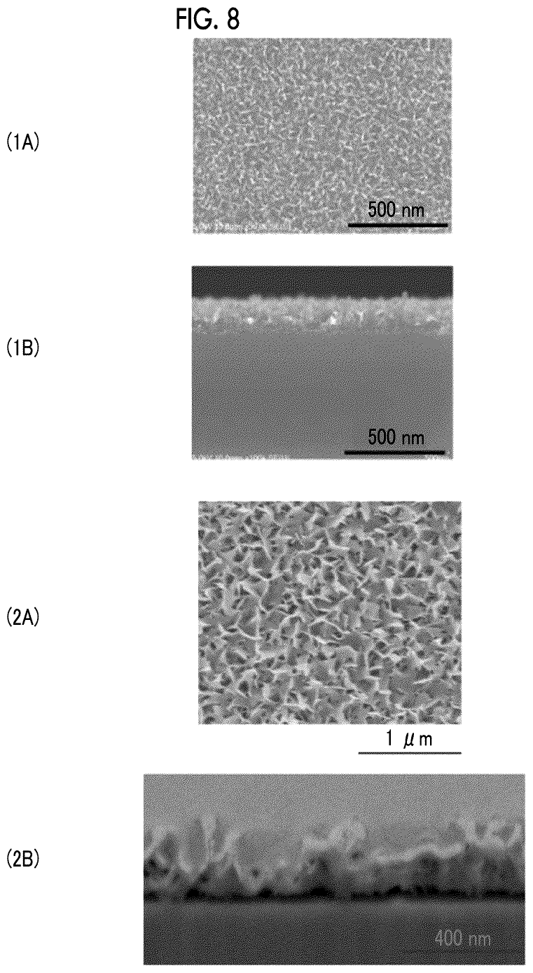

Regarding the average period, a spatial frequency spectrum is obtained to obtain a spatial frequency value having the maximum intensity, and a period is obtained from the spatial frequency value. Specifically, an SEM image of a fine irregular structure (moth eye structure) seen in a plan view was obtained by a scanning electron microscope at a magnification of 10,000 times, and a range of 1,000×680 pixels was cropped from the SEM image to perform a two-dimensional Fourier transform. The square intensity spectrum of the obtained two-dimensional spatial frequency was integrated in an azimuth direction and the intensity of the spectrum corresponding to the magnitude of the spatial frequency was obtained to calculate a relationship between the one-dimensional spatial frequency and the spectrum intensity (see FIG. 7). Then, a spatial frequency value having the maximum intensity (peak) was obtained by fitting the vicinity of the apex with a Gaussian function. For example, in a case where the spatial frequency value at which the intensity is maximum is 5 μm⁻¹, the period [μm] is ⅕=0.2, and the average period is 200 nm.

### Haze

A haze meter (SH7000: NIPPON DENSHOKU INDUSTRIES CO., LTD.) was used for haze measurement.

The haze [%] is represented by (amount of diffuse transmitted light/(amount of vertically transmitted light+ amount of diffuse transmitted light))× 100. A larger haze means a larger amount of diffuse transmitted light.

### Image Evaluation Method

Each sample was mounted on a general-purpose portable TV camera (body: Sony HDC-4300, lens: Fujinon UA18×7.6BERD) as a lens filter, and an image of a subject was captured to display the captured image on a monitor. This captured image was subjected to sensory evaluation according to the following evaluation standard.

A: No haze is noticeable at all. A clear image (black portion) is obtained.

B: A level at which the occurrence of scattering is not noticeable unless the image is viewed with caution.

C: A level at which the influence of scattering on the image is recognized.

D: A level at which a black part of the image is clearly influenced by scattering and appears white.

Dependence of Photocatalytic Activity on Ultraviolet Irradiation Energy (WAX test)

Vehicle wax (product name “New Wilson”, manufactured by WILLSON CO., LTD.) was rubbed on a sample surface using a cotton swab. After 24 hours or longer since the application of the wax, the wax applied to the sample surface was removed with a neutral detergent and water, and a contact angle θ1 of the sample surface from which the wax was removed to the water was measured. Then, the sample surface was irradiated with ultraviolet light, and after the irradiation, a contact angle θ2 of the sample surface to the water was measured again. A UV-B ultraviolet lamp 20WGL20SE manufactured by Sankyo Electric Works Co., Ltd. was used as a ultraviolet light source, and as irradiation conditions, the UV illuminance was 3 mw/cm² and the irradiation time was from 0.5 minutes to 42 minutes. The ultraviolet irradiation energy corresponds to 0.1 to 7.5 J/cm². In addition, DM300 manufactured by Kyowa Interface Science Co., Ltd. was used as a contact angle measuring device.

Refractive Index of Film

The measurement was performed by ellipsometry (J. A. Woolam Company, VASE).

### Test 1

Samples 1-1 to 1-8 of a mask in which a silicon oxide layer was provided on an optical substrate and a moth eye structure consisting of an aluminum nitride film was provided on a surface of the silicon oxide layer, and samples 2-1 to 2-8 in which the sample 1-8 was subjected to an etching treatment and a moth eye structure consisting of a silicon oxide layer was provided were produced, and various evaluations were performed thereon.

### Sample Production Method

A production method of the samples 1-1 to 1-8 was as follows.

A white substrate (B270i: manufactured by SCHOTT) having a diameter of 80 mm and a thickness of 2 mm was used as an optical substrate. On the white substrate, a silicon oxide layer of 1,000 nm was formed by a sputtering method, and an aluminum nitride film of 10 nm or 40 nm was further formed by the sputtering method. Next, a hot water treatment was performed to immerse the white substrate having the silicon oxide layer and the aluminum nitride film laminated thereon in hot water at 80° C. or 100° C. for 20 seconds or 3 minutes. Therefore, the aluminum nitride film was changed into a fine irregular layer consisting of alumina hydrate. Table 1 below shows the thickness of the aluminum nitride film, the hot water treatment temperature, and the immersion time for each of the samples 1-1 to 1-8.

A SiO₂ target was used to form the silicon oxide layer, and an Al target was used to form the aluminum nitride film. Sputtering conditions were as follows.
Sputtering Conditions for Silicon Oxide Layer

Input Power to Target: 500 W

VacuumDegree: 0.2 Pa, O₂ atmosphere (O₂ flow rate: 200 sccm)

No substrate heating
Sputtering Conditions for Aluminum Nitride Film

Input Power to Target: 600 W

VacuumDegree: 0.2 Pa, N₂ atmosphere (N₂ flow rate: 150 sccm)

No substrate heating

Regarding the samples 1-1 to 1-8 produced as described above, the sample production conditions and the results of measurement of the heights and the periods of the irregular structures are shown in Table 1. In addition, FIG. 7 shows spatial frequency spectra (relationship between the spatial frequency and the spectrum intensity) of the samples 1-1 to 1-8. The reciprocal of the spatial frequency indicating the intensity peak of the spatial frequency spectrum shown in FIG. 7 was calculated as an irregularity period.

TABLE 1

| | | Hot | | | | |
|---|---|---|---|---|---|---|
| | AlN | Water | | | | |
| | Film | Treatment | Immer- | Irreg- | Irreg- | |
| Sam- | Thick- | Temper- | sion | ularity | ularity | Haze at |
| ple | ness | ature | Time | Height | Period | 400 nm |
| No. | [nm] | [° C.] | [sec] | [nm] | [nm] | [%] |
| 1-1 | 10 | 80 | 20 | 50 | 77 | 0.13 |
| 1-2 | 10 | 80 | 180 | 70 | 81 | 0.08 |
| 1-3 | 10 | 100 | 20 | 90 | 88 | 0.05 |
| 1-4 | 10 | 100 | 180 | 80 | 141 | 0.05 |
| 1-5 | 40 | 80 | 20 | 60 | 67 | 0.18 |
| 1-6 | 40 | 80 | 180 | 134 | 132 | 0.08 |
| 1-7 | 40 | 100 | 20 | 160 | 91 | 0.08 |
| 1-8 | 40 | 100 | 180 | 176 | 86 | 0.05 |

As shown in Table 1, the irregularity height and the irregularity period of the fine irregular layer to be formed can be changed depending on the film thickness of the aluminum nitride, the hot water treatment temperature, and the immersion time. For each of the samples 1-1 to 1-8, the value of a haze was a very small value of 0.18% or less. In a case where the silicon oxide layer is etched with the fine irregular layer as a mask, the irregularities of the fine irregular layer are transferred to the silicon oxide layer. That is, a moth eye structure having an irregularity period corresponding to the irregularity period of the fine irregular layer of the mask is formed on the silicon oxide layer. A multilayer film including a silicon oxide layer having a moth eye structure obtained by etching using a mask with a small haze is expected to have a small haze.

The sample 1-8 of the mask was subjected to an etching treatment with the fine irregular layer as a mask to produce the samples 2-1 to 2-8 in which a moth eye structure consisting of a silicon oxide layer was provided. As the etching treatment, first, physical etching was performed, and then chemical etching was performed. The physical etching is performed to penetrate recessed portions of the fine irregular layer, and the silicon oxide layer is exposed. Thereafter, the chemical etching is performed to etch the silicon oxide layer exposed to the recessed portions of the fine irregular layer. The conditions for the physical etching and the chemical etching were as follows.

### Physical Etching Conditions

Inductively Coupled Plasma (ICP) Output: 300 W, Bias Output: 120 W

Etching Pressure: 3 Pa

Etching Gas: Ar (100 sccm), CHF₃ (10 sccm)

Substrate Temperature: 10° C.

Etching Time: 45 sec.
Chemical Etching Conditions

ICP Output: 500 W, Bias Output: 15 W

Etching Pressure: 0.6 Pa

Etching Gas: SF₆ (40 sccm), CHF₃ (40 sccm)

Substrate Temperature: 10° C.

Etching Time: 1 min. to 35 min. (varies depending on the sample)

The etching time for each of the samples 2-1 to 2-8 is shown in Table 2 below.

Regarding the samples 2-1 to 2-8, the chemical etching time, the haze measurement result, the sensory evaluation of the image, the measurement result of the water contact angle, the measurement result of the irregularity height, and the measurement result of the irregularity period are shown in Table 2.

TABLE 2

| | Chemical | | | Water | Irreg- | Irreg- |
|---|---|---|---|---|---|---|
| Sam- | Etching | Haze at | Sensory | Contact | ularity | ularity |
| ple | Time | 400 nm | Eval- | Angle | Height | Period |
| No. | [min.] | [%] | uation | [deg.] | [nm] | [nm] |
| 2-1 | 1 | 0.15 | A | 12.0 | 25 | 10 |
| 2-2 | 5 | 0.44 | A | 6.6 | 70 | 40 |
| 2-3 | 10 | 0.95 | B | 3.0 | 120 | 80 |
| 2-4 | 15 | 1.5 | B | 1.4 | 180 | 130 |
| 2-5 | 20 | 2.3 | C | 1.0 | 240 | 180 |
| 2-6 | 25 | 3.2 | C | 0.8 | 300 | 220 |
| 2-7 | 30 | 4.2 | D | 0.6 | 350 | 255 |
| 2-8 | 35 | 5.4 | D | 0.4 | 400 | 280 |

In the present test 1, the results of the sensory evaluation in the image evaluation method indicated that the haze is desirably 3.2% or less, more desirably 1.5% or less, and most desirably 0.44% or less. The smallness of the haze and the smallness of the water contact angle were in a mutually contradictory relationship, but it was confirmed that the smallness of the haze (haze 3.2% or less) and the smallness of the water contact angle (contact angle 5° or less) were achieved with an irregularity height in a range of 120 nm to 300 nm and an irregularity period in a range of 80 nm to 220 nm. In addition, it was confirmed that the haze tended to be reduced as the irregularity height and the irregularity period were reduced.

### Test 2

In the samples 1-1 to 1-8, aluminum nitride was used as a mask material. Regarding this, a sample A in which aluminum oxide was used as a mask material was produced and used for comparison with a case where aluminum oxide was used. Specifically, a sample A was produced, in which in the sample 1-8, an aluminum oxide film was formed instead of the aluminum nitride film to form a fine irregular layer. The sample A was produced by forming an aluminum oxide film with a film thickness of 40 nm and performing a hot water treatment under the same conditions as those for the sample 1-8. That is, as hot water treatment conditions for the sample A, the hot water treatment temperature was set to 100° C., and the immersion time was set to 180 seconds. (1A) in FIG. 8 is an SEM image of a surface of the sample 1-8, and (1B) in FIG. 8 is an SEM image of a cross section of the sample 1-8. (2A) in FIG. 8 is an SEM image of a surface of the sample A, and (2B) in FIG. 8 is an SEM image of a cross section.

It is found from (1A) to (2B) of FIG. 8 that, in a case where the hot water treatment is performed under the same conditions, the aluminum nitride film has a lower irregular height and a smaller irregularity period than the aluminum oxide film. Specifically, the fine irregular layer of the sample 1-8 had an irregularity period of 86 nm and an irregularity height of 176 nm, whereas the fine irregular layer of the sample A had an irregularity period of 300 nm and an irregularity height of 280 nm. In addition, the haze of the sample A was approximately 3% to 5%, which was extremely large compared to the samples 1-1 to 1-8.

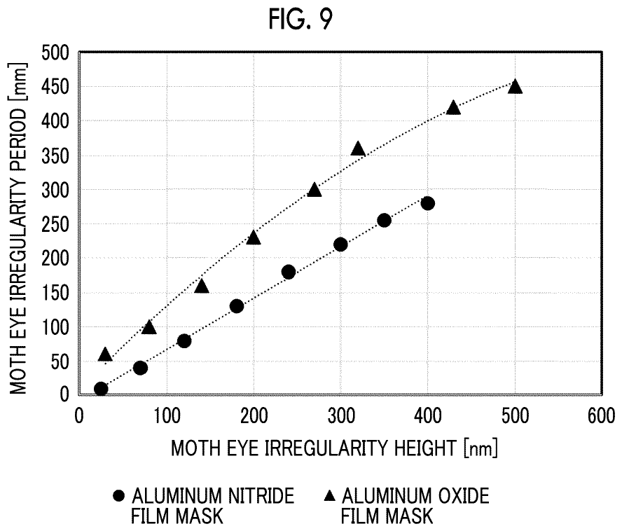

Further, an etching treatment was performed on the sample A (the sample in which aluminum oxide was used instead of aluminum nitride for the sample 1-8) under the same conditions as those for the samples 2-1 to 2-8 to produce samples 3-1 to 3-8. Regarding the samples 3-1 to 3-8, the irregularity height and the irregularity period were measured in the same manner as in the samples 2-1 to 2-8. FIG. 9 is a graph showing the dependence on the mask material for the moth eye structure. Each of the samples 2-1 to 2-8 with the aluminum nitride film mask and the samples 3-1 to 3-8 with the aluminum oxide film mask is plotted on a graph whose vertical axis is for the irregularity period (in FIG. 9, moth eye irregularity period) and horizontal axis for the irregularity height (in FIG. 9, moth eye irregularity height). It is found from FIG. 9 that, in comparison, at the same irregularity height, a smaller irregularity period is made in a case where the aluminum nitride film is used as a mask material.

From the results of the test 1 and the test 2, it is considered that, in a case where a fine irregular layer consisting of alumina hydrate is used as a mask in the production of the multilayer film according to the embodiment of the present disclosure, aluminum nitride is more preferably used as a mask material than aluminum oxide from the viewpoint of suppressing haze.

### Test 3

A plurality of samples 4-1 to 4-5 having different film thicknesses of a titanium oxide layer were produced, and the photocatalytic function was evaluated.

Samples 4-1 to 4-5 were produced by forming a titanium oxide layer having a film thickness shown in Table 3 on an optical substrate, and then forming a silicon oxide layer having a moth eye structure. The production conditions for the silicon oxide layer having a moth eye structure of each of the samples 4-1 to 4-5 were the same as those for the sample 2-4.

TABLE 3

| | Titanium Oxide Film Thickness |
|---|---|
| Sample No. | [nm] |
| 4-1 | 100 |
| 4-2 | 200 |
| 4-3 | 250 |
| 4-4 | 300 |
| 4-5 | 500 |

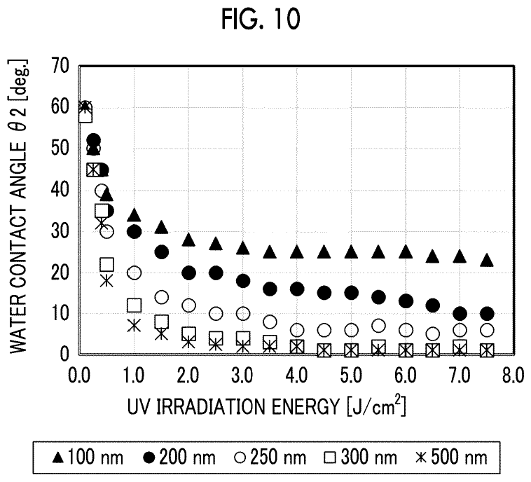

Regarding the samples 4-1 to 4-5, results of measurement of the dependence of the photocatalytic activity on ultraviolet irradiation energy (WAX test) are shown in FIG. 10. The vertical axis of FIG. 10 represents a water contact angle θ2 measured after irradiation of the sample surface with ultraviolet rays. Water contact angles of the samples 4-1 to 4-5 were substantially 5° or less before the WAX test, and contact angles θ1 were all approximately 60° in the WAX test. Smaller 02 means a higher self-cleaning effect. In the samples 4-1 to 4-5, it was confirmed that, in a case where the thickness of the titanium oxide layer was 300 nm or less and the ultraviolet irradiation energy was 2 J/cm², the water contact angle θ2 was less than 5°, resulting in a highly efficient self-cleaning effect.

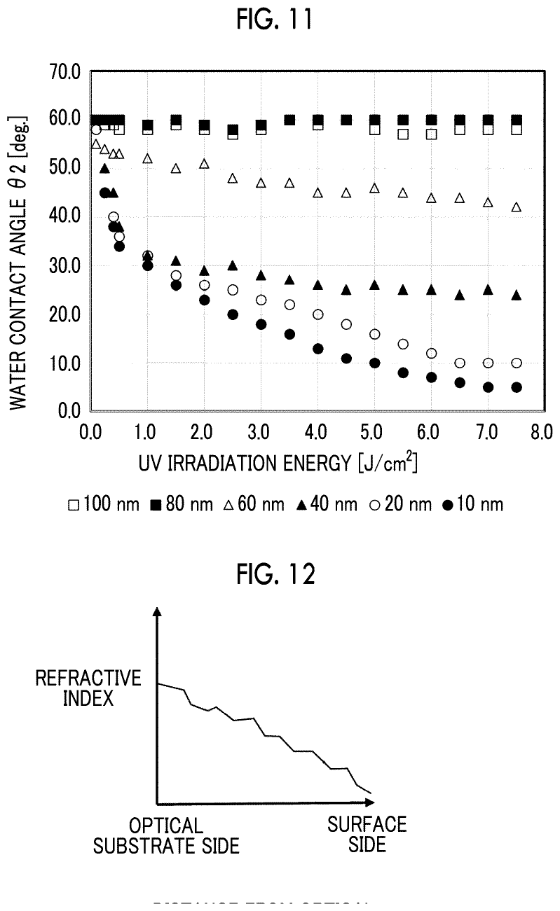

As a comparative sample, a sample in which a titanium oxide layer and a silicon oxide layer were formed on a white substrate was produced. In the comparative sample, no moth eye structure was formed on a surface of the silicon oxide layer, and a silicon oxide layer having a smooth surface was provided. Comparative examples in which the film thickness of the titanium oxide layer was fixed to 300 nm and the film thickness of the silicon oxide film was 10 nm, 20 nm, 40 nm, 80 nm, and 100 nm were produced, and the WAX test was performed. FIG. 11 shows results of measurement of the dependence of the photocatalytic activity of the comparative samples on ultraviolet irradiation energy. Water contact angles of the comparative samples were substantially about 5° to 10° before the WAX test, and contact angles θ1 were all approximately 60° in the WAX test. In the silicon oxide layer having a smooth surface, it was possible to set a water contact angle θ2 of 10° or less in a case where the film thickness was 10 nm to 20 nm and the ultraviolet dose was 6.5 J/cm² or more, and it was possible to reduce the water contact angle θ2 to approximately 5° in a case where the film thickness was 10 nm and the ultraviolet dose was 7.0 J/cm² or more. In the comparative samples, it was found that it is necessary to increase the ultraviolet dose in order to obtain a sufficient self-cleaning effect. In addition, it was found that the thicker the silicon oxide layer, the less photocatalytic function the titanium oxide layer exhibits.

It is clear from the comparison between FIGS. 10 and 11 that by providing the silicon oxide film having a moth eye structure on the surface thereof, it is possible to effectively exhibit the photocatalytic function of the titanium oxide layer provided under the silicon oxide film.

Test 4

Samples 5-1 to 5-6 of an optical member including a multilayer film including an interlayer were produced as in the optical member 2 shown in FIG. 2, and the photocatalytic function and the antireflection function were evaluated.

The sample 5-1 was produced by forming an interlayer obtained by laminating a titanium oxide layer (TiO₂-x) and a silicon oxynitride layer (SiOxNy) one by one on an optical substrate, forming a titanium oxide layer exhibiting a photocatalytic function, and further forming a silicon oxide layer (SiO₂ moth eye) having a moth eye structure. The production conditions for the silicon oxide layer having a moth eye structure were the same as those for the sample 2-4. The layer structure of the sample 5-1 is shown in Table 4. Layer Nos. 3 and 4 correspond to the interlayer, and Layer No. 2 corresponds to the titanium oxide layer exhibiting a photocatalytic function.

TABLE 4

| | | Refractive Index | Film Thickness |
|---|---|---|---|
| Layer No. | Substance Name | at 540 nm | [nm] |
| 1 | SiO₂ Moth Eye | 1~1.46 | 250 |
| 2 | TiO₂₋ₓ | 2.32 | 300 |
| 3 | SiOₓN_{y} | 1.51 | 57 |
| 4 | TiO₂₋ₓ | 2.32 | 150 |
| | BK-7 (substrate) | 1.52668 | |

For the sample 5-2, the film thickness of the titanium oxide layer exhibiting a photocatalytic function of Layer No. 2 of the sample 5-1 was changed to 250 nm. For the sample 5-3, the film thickness of the titanium oxide layer exhibiting a photocatalytic function of Layer No. 2 of the sample 5-1 was changed to 500 nm.

The sample 5-4 had a configuration including, instead of the interlayer of the sample 5-1, an interlayer obtained by laminating six alternating titanium oxide layers and silicon oxynitride layers. The layer structure of the sample 5-4 is shown in Table 5. Layer Nos. 3 to 8 correspond to the interlayer, and Layer No. 2 corresponds to the titanium oxide layer exhibiting a photocatalytic function.

TABLE 5

| | | Refractive Index at | Film Thickness |
|---|---|---|---|
| Layer No. | Substance Name | 540 nm | [nm] |
| 1 | SiO₂ Moth Eye | 1~1.46 | 250 |
| 2 | TiO₂ | 2.32 | 300 |
| 3 | SiOₓN_{y} | 1.51 | 66 |
| 4 | TiO₂ | 2.32 | 156 |
| 5 | SiOₓN_{y} | 1.51 | 10 |
| 6 | TiO₂ | 2.32 | 6 |
| 7 | SiOₓN_{y} | 1.51 | 10 |
| 8 | TiO₂ | 2.32 | 6 |
| | S-LAH58 (substrate) | 1.88319 | |

For the sample 5-5, the film thickness of the titanium oxide layer exhibiting a photocatalytic function of Layer No. 2 of the sample 5-4 was changed to 250 nm. For the sample 5-6, the film thickness of the titanium oxide layer exhibiting a photocatalytic function of Layer No. 2 of the sample 5-4 was changed to 500 nm.

FIG. 12 shows a refractive index distribution of the moth eye structure of the silicon oxide layer. The refractive index of the silicon oxide layer having a moth eye structure changes between 1 and 1.46. In the silicon oxide layer, the refractive index on the optical substrate side is the highest, and the refractive index on the surface side on which light from outside the optical substrate is incident is the lowest. In addition, a change in refractive index per unit length from the optical substrate side to the surface side is very small. In such a refractive index distribution, the wavelength range characteristics and the incidence angle characteristics of the reflectivity are excellent.

The reflectivity of each sample was measured by the following measuring method.

Reflectivity

A microspectrophotometer (USPM-PU: Olympus Corporation) was used for reflectivity measurement. The reflectivity was measured for each wavelength in a case where light was incident on the optical member at an incidence angle of 5° (vertical incidence).

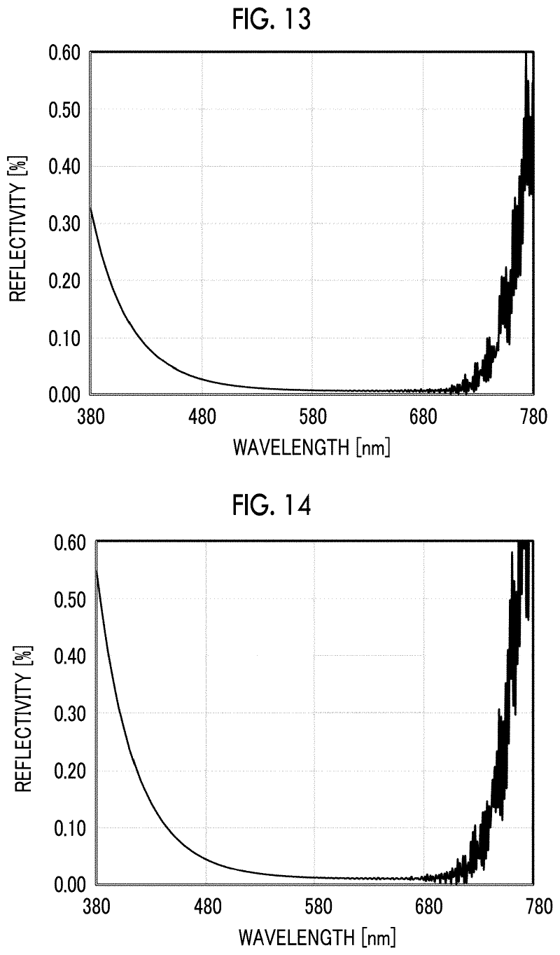

FIG. 13 shows results of measurement of the reflectivity of the sample 5-1. FIG. 14 shows results of measurement of the reflectivity of the sample 5-4. An optical member having an extremely good antireflection function was obtained by providing both the moth eye structure and the interlayer.

Results of various evaluations of the samples 5-1 to 5-6 are shown in Table 6. It is considered that, in a case where the photocatalytic layer consisting of titanium oxide is thin, the average reflectivity can be reduced, but the water contact angle after the WAX test is large and the self-cleaning effect is small. In a case where a photocatalytic layer of 300 nm was provided, the balance between the characteristics was good.

TABLE 6

| | | Water | | | |
|---|---|---|---|---|---|
| | | Contact | Water Contact | Average | |
| | Titanium | Angle | Angle θ2 After | Reflectivity | |
| | Oxide | (before | WAX Test | (wavelength | |
| | Film | WAX | (after irradiation | 400 to | Haze at |
| Sample | Thickness | test) | at 2 J/cm²) | 700 nm) | 400 nm |
| No. | [nm] | [deg.] | [deg.] | [%] | [%] |
| 5-1 | 300 | 2 | 5 | 0.03 | 1.8 |
| 5-2 | 250 | 2 | 15 | 0.02 | 1.8 |
| 5-3 | 500 | 2 | 3 | 0.12 | 2 |
| 5-4 | 300 | 3 | 5 | 0.05 | 2.5 |
| 5-5 | 250 | 3 | 15 | 0.04 | 2.5 |
| 5-6 | 500 | 2 | 3 | 0.22 | 2.5 |

Regarding the above embodiments, the following supplementary notes are further disclosed.

Supplementary Note 1

A multilayer film that is provided on a substrate, the multilayer film comprising:
a silicon oxide layer that has a moth eye structure on a surface thereof and exhibits hydrophilicity; and
a titanium oxide layer that is disposed in contact with the silicon oxide layer and exhibits a photocatalytic function.

Supplementary Note 2

The multilayer film according to supplementary note 1,
in which the titanium oxide layer is disposed between the silicon oxide layer and the substrate.

Supplementary Note 3

The multilayer film according to supplementary note 1 or 2,
in which the silicon oxide layer includes a functional group exhibiting hydrophilicity.

Supplementary Note 4

The multilayer film according to any one of supplementary notes 1 to 3,
in which the moth eye structure has a height of 120 nm to 400 nm, and a period of 80 nm to 220 nm.

Supplementary Note 5

The multilayer film according to any one of supplementary notes 1 to 4, in which the titanium oxide layer has a film thickness of 250 nm to 500 nm, and ultraviolet irradiation energy necessary for photocatalytic activity is 7 J/cm² or less.

Supplementary Note 6

The multilayer film according to any one of supplementary notes 1 to 5, in which a water contact angle is 5° or less.

Supplementary Note 7

The multilayer film according to any one of supplementary notes 1 to 6, in which a haze is 3.2% or less.

Supplementary Note 8

The multilayer film according to any one of supplementary notes 1 to 7,
in which an interlayer having an antireflection function is provided between the substrate and the titanium oxide layer.

Supplementary Note 9

An optical member comprising:
the multilayer film according to any one of supplementary notes 1 to 8; and
the substrate with the multilayer film provided on a surface thereof, in which the substrate is an optical substrate having a flat surface or an optical lens having a predetermined curvature.

Supplementary Note 10

The optical member according to supplementary note 9, in which reflectivity is 0.05% or less in a case where light having a wavelength of 400 nm to 700 nm is vertically incident.

Supplementary Note 11

An imaging device comprising: the optical member according to supplementary note 9 or 10.

Supplementary Note 12

A method of producing the multilayer film according to any one of supplementary notes 1 to 9, the method comprising:
a film forming step of sequentially forming a titanium oxide layer and a silicon oxide layer on an optical substrate by a sputtering method;
a mask forming step of forming a fine irregular layer consisting of alumina hydrate on a surface of the silicon oxide layer; and
an etching step of etching the silicon oxide layer using the fine irregular layer as a mask.

What is claimed is:

1. A multilayer film that is provided on a substrate, the multilayer film comprising:
a silicon oxide layer that has a moth eye structure on a surface thereof and exhibits hydrophilicity; and
a titanium oxide layer that is disposed in contact with the silicon oxide layer and exhibits a photocatalytic function.

2. The multilayer film according to claim 1,
wherein the titanium oxide layer is disposed between the silicon oxide layer and the substrate.

3. The multilayer film according to claim 1,
wherein the silicon oxide layer includes a functional group exhibiting hydrophilicity.

4. The multilayer film according to claim 1,
wherein the moth eye structure has a height of 120 nm to 400 nm, and
a period of 80 nm to 220 nm.

5. The multilayer film according to claim 1,
wherein the titanium oxide layer has a film thickness of 250 nm to 500 nm, and
ultraviolet irradiation energy necessary for photocatalytic activity is 7 J/cm² or less.

6. The multilayer film according to claim 1,
wherein a water contact angle is 5° or less.

7. The multilayer film according to claim 1,
wherein a haze is 3.2% or less.

8. The multilayer film according to claim 1,
wherein an interlayer having an antireflection function is provided between the substrate and the titanium oxide layer.

9. An optical member comprising:
the multilayer film according to claim 1; and
the substrate with the multilayer film provided on a surface thereof,
wherein the substrate is a flat substrate having a flat surface or an optical lens having a predetermined curvature.

10. The optical member according to claim 9,
wherein reflectivity is 0.05% or less in a case where light having a wavelength of 400 nm to 700 nm is vertically incident.

11. An imaging device comprising:
the optical member according to claim 9.

12. A method of producing the multilayer film according to claim 1.
